(19) United States
(12) Patent Application Publication
(10) Pub. No.: US 2020/0406812 A1
(43) Pub. Date: Dec. 31, 2020

(54) MODULAR LIGHT-SIGNALING DEVICE FOR A VEHICLE

(71) Applicants: VIGNAL SYSTEMS, Corbas (FR); VIGNAL CEA SA, Rancate (CH)

(72) Inventors: Jean-Marc MOLINES, Corbas (FR); Guillaume DUPUIS, Corbas (FR); Stefano TASSI, Rancate (CH)

(73) Assignees: VIGNAL SYSTEMS, CORBAS (FR); VIGNAL CEA SA, Rancate (CH)

(21) Appl. No.: 16/912,134

(22) Filed: Jun. 25, 2020

(30) Foreign Application Priority Data
Jun. 25, 2019 (FR) 19/06884

(51) Int. Cl. B60Q 1/26; B60Q 1/32

(52) U.S. Cl. CPC B60Q 1/2611; B60Q 1/32

(57) ABSTRACT

A modular light-signaling device for a vehicle includes a plurality of modules, each module being provided with one or several lighting function(s). The plurality of modules include at least one master module and at least one slave module, the master module having a control unit adapted to pilot the lighting function(s) of the master module and of the slave module.

### CROSS-REFERENCE TO RELATED APPLICATIONS

This application claims priority to and the benefit of FR 19/06884 filed on Jun. 25, 2019. The disclosure of the above application is incorporated herein by reference.

### FIELD

The present disclosure relates to a light-signaling device of the so-called “light bar” type for vehicles. For example, such a light-signaling device may be fastened on the roof of the vehicle.

### BACKGROUND

The statements in this section merely provide background information related to the present disclosure and may not constitute prior art.

Light bars for vehicles belong to the category of emergency vehicle lightings useful in the road traffic field.

Emergency vehicle lightings are devices allowing signaling vehicles having a particular mission. For example, these vehicles may consist of vehicles whose mission implies that they have a positioning that makes them vulnerable to incidents: that is for example the case of vehicles for work on the pavement (construction, road maintenance, etc.), vehicles for emergency-response in the event of an accident (tow truck, roadside assistance, etc.), slow and/or cumbersome vehicles (special convoy, etc.). These vehicles may also consist of vehicles whose mission has an urgent nature authorizing them to get rid of some traffic constraints (traffic lights, priorities, etc.) such as police and gendarmerie vehicles, fire department vehicles, ambulances, customs vehicles, transplants transportation vehicles.

Emergency vehicle lighting is often in the form of emergency lights. These may be placed at different locations on the vehicle, for example at the front and/or on the roof, in the form of a light that could be fixed, rotating, scrolling or blinking, individual or multiple in a bar (or ramp), using different types of light sources, with different colors, for example, blue, red, amber.

In operation, the emergency vehicle lighting such as light bars implement a plurality of light sources which may be fixed, rotate and/or blink. These different light sources may have different functions. In general, the following functions are found:

Flasher: a flasher includes several groups of light sources which are activated, individually and sequentially, according to a predetermined sequence. The groups of light sources may be activated in the order of their positioning, for example in order to indicate to a driver of another vehicle a move to perform, in the direction corresponding to the direction of successive lighting of the groups of light sources. Thus, the flasher function is intended to regulate road traffic;

Flashing beacon: the flashing beacon comprises a light source generating a lighting and a rotatably-simulated luminous warning signal;

Work lamp: the work lamp, or light, comprises a light source projecting a bright white light to illuminate the work site at night fall or early in the morning. Such a work lamp allows illuminating an intervention area of an operator to facilitate and secure his work;

Side-light: the side-light comprises a light source generating a lighting intended to emit light from the sides of the vehicle, for example in order to illuminate the traffic lanes, find the location of load pallets, identify the building numbers in the darkness, etc.;

3-function repeating light: this light replicates the stop/position/turn indicator functions of the corresponding lights of the vehicle and serves as an additional warning at height to signal the changes in the behavior of the vehicle. They are particularly useful for dangerous interventions on highways or when the intervention is likely to hide the lights installed on the vehicle.

Some of the elements of known light-signaling devices generate an electromagnetic noise likely to interfere with other electronic or light-emitting components of the vehicle. In order to limit these electromagnetic interferences, it has been suggested to implement electromagnetic shields, in particular around the cables powering the different light sources of these light bars.

Nonetheless, with the increase in the number of light sources having different and various functions on light bars, the number of wires of the dedicated cable network has also increased, and the electromagnetic compatibility with the other components of the vehicle is not always satisfactory. The necessary shielding becomes too complicated to set up.

Moreover, the increase in the number of light sources involved in the light bar has also increased the probability that one of these sources becomes defective. In such a case, the light source, sometimes the entire light bar, should be replaced by a new light source or a bar in working condition. Such a repair operation requires time and causes a temporary stoppage of the vehicle, detrimental to the mission for which the vehicle is intended.

To overcome these drawbacks, modular light bars have been proposed, that is to say having several modules, such that one module having a defective light source could be replaced by another module, without having to change the entire light bar.

Nonetheless, the presence of several modules and the increase in the number of light sources having different and various functions on modular light bars also results in an increase in the number of constraints, such as compatibility of the electric and mechanical connections between the light sources and the modules, proper operation check-up tests, etc., when the replacement of one or several module(s) in the bar is necessary.

Moreover, the known modular light bars do not allow addressing the varying needs of users, neither completely nor simply. Indeed, the structure of the known modules limits possibilities for customization.

### SUMMARY

This section provides a general summary of the disclosure and is not a comprehensive disclosure of its full scope or all of its features.

The present disclosure provides a modular light-signaling device comprising a plurality of modules, wherein each module may be set in place or replaced by another module in an extremely simple and quick way, the modules being, in one form, connected to one another using a connection other than a wired connection.

The present disclosure relates to a modular light-signaling device for a vehicle, comprising a plurality of modules, each module comprising an electronic board on which is/are disposed one or several light source(s), each light source having a dedicated lighting function, the plurality of modules comprising at least one master module and at least one slave module, said master module comprising a control unit adapted to pilot the lighting function(s) of said master module and of said slave module. In addition, the modules are mechanically connected to one another by a male/female interlocking type linkage, and each electronic board comprises at least one connector, the electronic boards of two adjacent modules being connected by said connectors, the connection between the different modules being free of any wired link.

In one form, the slave module is free of any control unit, the slave module being piloted by the master module. Thus, the slave module has a simple structure and may be replaced by another slave module in a simple and quick way.

In another form, the slave module is located on the light-signaling device in a position symmetrical to the master module with respect to the center of the signaling device.

Thus, the present disclosure provides a light-signaling device whose modularity, and therefore adaptability to the specific needs of the users, is extremely large and simple to implement. Indeed, it simply entails selection of the desired modules amongst all modules that are available, and then assembling them. This may be carried out quite easily via the male/female interlocking, the electronic connection being automatically performed via the connectors, without any additional intervention of an operator. This allows limiting the mounting time and the risks of error during such mounting.

A male/female interlocking type mechanical linkage is also extremely simple to tie and untie. Hence, the replacement of one module by another module of the same type (master or slave) is extremely easy and quick to carry out. This allows limiting the downtime of a vehicle for such a repair.

Another significant advantage of the present disclosure is to enable a late customization of the light-signaling device, thanks to the design and manufacture of several references of subsets in the form of modules that can be easily assembled/connected during a first set-up or during a replacement. Each module may be in the form of a case, which in one form are in one-piece, closed and which cannot be open by the user, whose inner structure is therefore definitive and cannot be modified. The mechanical assembly of the selected cases allows forming the light-signaling device quickly, the electronic connection being established between the modules and the control unit of the master module ensuring the proper operation of the light sources of the master module and of the other modules.

The absence of a wired link for connecting two adjacent modules considerably simplifies the connection and makes it more robust and more reliable. Furthermore, electromagnetic compatibility issues are thus reduced without having to resort to shields or other protective means.

Hence, in the modular light-signaling device according to the present disclosure, the connectors provide the electronic connection between two adjacent modules, that is to say electric power transmission as well as data communication.

To this end, in each module, there are conductors dedicated to the electric power supply (conductor+ and grounding conductor), as well as conductors dedicated to data communication, such as CAN buses or the same. These conductors connect an appropriate terminal of the connector and the control unit, on the one hand, and connect each light source to the control unit, on the other hand.

In one form, these conductors are in the form of tracks formed on each electronic board. In this manner, not only is there no wired link between the modules, but also no wired link inside each of the modules, which limits as much the electromagnetic compatibility issues.

The modules may be mechanically connected to one another by said connectors. With this form, the connectors ensure both the electronic connection and the mechanical linkage. Thus, such a light-signaling device is quite simple both structurally and with regards to the implementation thereof.

According to a possible form, a connector includes pins of a first type, in the form of a plate, and pins of a second type, in the form of a jaw. The connectors of two adjacent modules intended to be connected to one another are identical and arranged on the respective electronic boards of the modules so that the jaws of one connector could receive the plates of the other connector. This allows providing, via the connectors, both the mechanical linkage and the electronic connection between two adjacent modules.

Each module may comprise a pre-guide member intended to cooperate with the pre-guide member of an adjacent module so as to guide the mutual approach of said modules before the mechanical and electronic assembly thereof.

For example, the pre-guide member may be formed on, or belong to, the electronic board. In this case, in one form, the pre-guide member extends at least partially beyond the connector so as to be able to cooperate with the pre-guide member of the adjacent module before connection of the two connectors. The pre-guide member may have a particular shape having portions with complementary shapes, for example at least one tooth and one recess, so that a guide member of an electronic board could fit into a guide member of the adjacent electronic board, which may be disposed in the reverse way.

The electronic board of a module may include a main portion and a protrusion projecting from the main portion, the pre-guide member being formed on the protrusion, and the connector being mounted on the protrusion. In one form, the protrusion may extend beyond the case defined by the module, so as to enable mounting.

The plurality of modules may further comprise one or several secondary module(s), the control unit of said master module being adapted to pilot the lighting function(s) of said secondary module(s). Thus, like the slave module, the secondary modules are in one form free of any control unit, and have a simple structure. Hence, they may be replaced by other secondary modules in an extremely simple and quick way.

In one form, the master module is positioned at a first end of the light-signaling device, the slave module being in this case positioned at the opposite end of the light-signaling device.

Thus, in the case where the light-signaling device further comprises one or several secondary module(s), this/these secondary module(s) is/are positioned in the central region of the light-signaling device, in other words between the master module, forming a first end of the signaling device, and the slave module, forming the opposite end of the signaling device. A secondary module may typically have a plane of symmetry which, when mounted on a vehicle, corresponds to a longitudinal vertical plane of the vehicle. The symmetry does not concern the arrangement of the components on the electronic board.

The light-signaling device according to the present disclosure may include as many secondary modules as necessary to the desired application for the vehicle, for example one, two, three, four secondary modules, and more where appropriate.

In one form, the connectors are configured so as to achieve a connection between CAN bus type links, or any other multiplexed communication support, such as a LIN bus, provided on the electronic boards of the adjacent modules, so as to provide data transmission between said modules. Thus, communications between the different modules are devoid of any wired link.

Thus, the light-signaling device according to the present disclosure allows for a good electromagnetic proximity.

Thus, each light source of each module receives the information necessary to the operation thereof from the control unit of the master module via a printed circuit in the electronic board(s) of the modules and, where appropriate, via the corresponding connectors.

A light source of the master module receives the information necessary to the operation thereof from the control unit of the master module via the printed circuit in the electronic board of the master module. A light source of a slave or secondary module receives the information necessary to the operation thereof from the control unit of the master module via the printed circuit in the electronic board of the master module, the connectors of the master module and of the slave or secondary module, and the printed circuit in the electronic board of the slave or secondary module.

In one form, the master module receives the electric power necessary to the operation of all of the modules of the light-signaling device via a wired link communicating with an electric power source external to the signaling device. In one form, the wired link with the external electric power source is the unique wired link of the light-signaling device according to the present disclosure. Thus, the electromagnetic compatibility of the light-signaling device according to the present disclosure is quite effective.

The lighting functions of the modules of the plurality of modules may be selected from flashers, flashing beacons, work lamps, side-lights, 3-function repeating lights, traffic lights and the combinations thereof. For example, the master module and/or the slave module, which are in one form located at the ends of the light-signaling device, may comprise light sources having side-lights functions as defined hereinabove. Alternatively or in combination, they may also comprise light sources having 3-function repeating lights.

In one form, each module may comprise an indicator light source, adapted to light up when said module is defective, for example in the case where it does not function at all or does not function properly. An example of a faulty functioning would be the amber-color lighting of one module whereas all other modules light up in blue, while the information programmed and sent by the control unit of the master module intended a blue-color lighting for all modules.

In one form, the light-signaling device according to the present disclosure comprises a frame adapted to support all of the modules forming the signaling device. The frame may comprise a fastening device for fastening the frame, and therefore the light-signaling device, on a bodywork element of the vehicle, for example on the roof of the vehicle.

The present disclosure also relates to a vehicle comprising a light-signaling device as hereinabove, fastened on said vehicle, for example on a roof of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view of the rear of a vehicle provided with a modular light-signaling device according to the present disclosure;

FIG. 2 is an exploded perspective view of the assembly of the electronic boards of three modules of a light-signaling device according to the present disclosure;

FIG. 3 is a perspective view of the electronic board of a master module of the light-signaling device according to the present disclosure, provided with its light sources;

FIG. 4 is an exploded and partial perspective view of a light-signaling device according to the present disclosure with four modules;

FIG. 5 is a perspective view of two modules of the light-signaling device according to the present disclosure before mechanical interlocking;

FIG. 6 is a perspective view of the two modules of FIG. 5 after mechanical interlocking;

FIG. 7 is a perspective view of a light-signaling device according to the present disclosure with three modules;

FIG. 8 is a perspective view of an electronic board of a secondary module, showing a first face, according to the present disclosure;

FIG. 9 is a plan view of the electronic board of FIG. 8, showing a second face; and

FIG. 10 illustrates the connection of two connectors of adjacent modules according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring to FIG. 1, a modular light bar 1 is configured to be positioned at the front or on the roof, on the roof in the represented example, of a vehicle 100 having a particular mission, such as for example vehicles for work on the pavement, emergency services vehicles, such as ambulances, fire department vehicles, police vehicles, etc., which must signal their presence to the other users of the roadways, for safety reasons. Thus, the modular light bar 1 according to the present disclosure is intended to project light and/or special lightings seen by most everyone.

In the example represented in FIG. 1, the modular light bar 1 comprises four modules 2, including one master module 2a, located at a first end of the modular light bar 1, one slave module 2b, located at the opposite end of the modular light bar 1, and two secondary modules 2c, located between the master module 2a and the slave module 2b, in other words at the center of the modular light bar 1. All of the modules 2 of the modular light bar 1 are provided with one or several lighting function(s).

By lighting functions, within the meaning of the present application, the following functions should be understood more specifically:

Flasher: a flasher includes several groups of light sources which are activated, individually and sequentially, according to a predetermined sequence. The groups of light sources may be activated in the order of their positioning, for example in order to indicate to a driver of another vehicle a move to perform, in the direction corresponding to the direction of successive lighting of the groups of light sources. Thus, the flasher function is intended to regulate road traffic;

Flashing beacon: the flashing beacon comprises a light source generating a lighting and a rotatably-simulated luminous warning signal;

Work lamp: the work lamp, or light, comprises a light source projecting a bright white light to illuminate the work site at night fall or early in the morning. Such a work lamp allows illuminating an intervention area of an operator to facilitate and secure his work;

Side-light: the side-light comprises a light source generating a lighting intended to emit light from the sides of the vehicle, for example in order to illuminate the traffic lanes, find the location of load pallets, identify the building numbers in the darkness, etc.;

3-function repeating light: this light replicates the stop/position/turn indicator functions of the corresponding lights of the vehicle and serves as an additional warning at height to signal the changes in the behavior of the vehicle. They are particularly useful for dangerous interventions on highways or when the intervention is likely to hide the lights installed on the vehicle;

Traffic light: this light provides an indication to deviate or direct the flow of vehicles to the left or to the right or to both directions for example in order to avoid an obstacle.

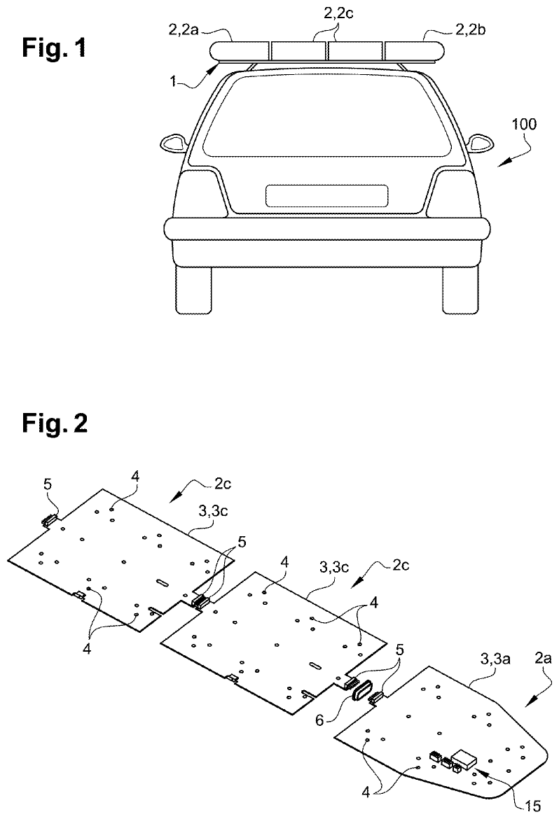

The master module 2a further comprises a control unit 15 (see FIG. 2) adapted to pilot the lighting function(s) of all of the other modules, namely the slave module 2b and the secondary modules 2c.

In the modular light bar 1 according to the present disclosure, the master module 2a and the slave module 2b are indispensable, the secondary modules 2c being optional. In general, the slave module 2b is located symmetrically to the master module 2a with respect to the center of the modular light bar 1. The modular light bar 1 may include as many secondary modules 2c as necessary for the intended application of the vehicle 100.

Thus, in one form, the slave module 2b and the secondary modules 2c are free of any control unit, and have a simple structure. Hence, they may be replaced by other modules of the same type (slave or secondary) in a particularly simple and quick way.

Referring to FIG. 2, for each module 2, the lighting function(s) are produced by light sources carried by an electronic board 3.

Referring to FIG. 2, there are represented the electronic boards 3 for the master module 2a and the two secondary modules 2c of FIG. 1. Thus, more specifically, in this figure, are represented the electronic board 3a of the master module 2a, and the electronic boards 3c of the two modules 2c.

Each electronic board 3 comprises a printed circuit in communication with ports 4 intended to receive light sources. Each electronic board (3, 3a, 3c) communicates with the adjacent electronic board (3, 3a, 3c) by means of a CAN bus type link. Thus, the electronic board 3a of the master module 2a, which is located at one end of the modular light bar 1, comprises a connector 5 adapted to be connected to a complementary connector 5 of the electronic board 3c of the adjacent secondary module 2c. Each of the electronic boards 3c of the secondary modules 2c comprises two such connectors 5, opposite to one another, each connector 5 of these boards being intended to be connected with the connector 5 of the electronic board 3 of the adjacent module in order to connect said electronic board 3c of the secondary module 2c with the electronic board (3a, 3c) of the adjacent module (2a, 2c).

The connection of the modules 2 via the connectors 5, for electric power supply as well as for data transmission, allows getting rid of any wired link between the modules 2 forming the modular light bar 1. Thus, communication between the different modules 2 are free of any wired link.

Thus, the modular light bar 1 according to the present disclosure allows for a good electromagnetic proximity.

In FIG. 2, the electronic boards 3c of both secondary modules 2c are connected to one another via their connectors 5. The connection between the electronic board 3a of the master module 2a and the electronic board 3c of the adjacent secondary module is shown before completion. As shown in this figure, the connection may comprise a sealing gasket 6.

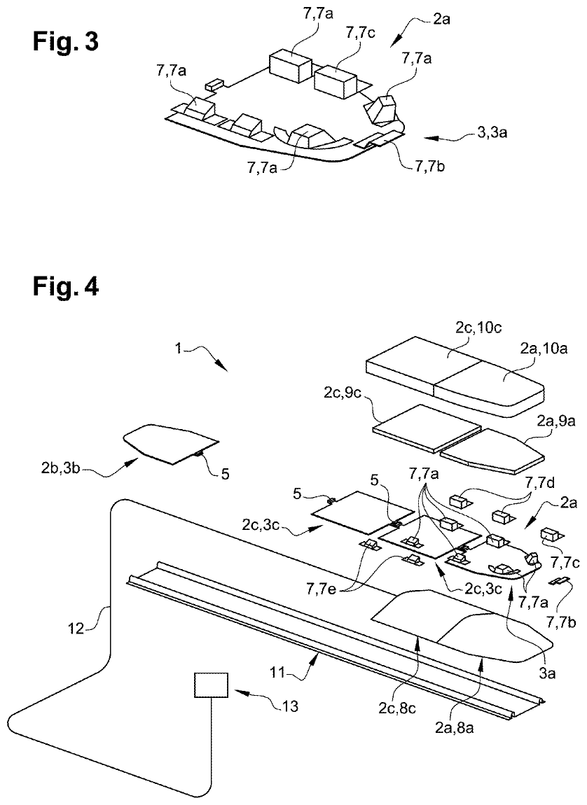

Referring to FIG. 3, there is shown the electronic board 3a of the master module 2a provided with the light sources 7 that will provide the lighting functions of the master module 2a, the light sources 7 being disposed in the ports 4 (see FIG. 2).

In this figure, there are shown the light sources 7 providing the following functions:

four light sources 7a: flashing beacons functions;

one light source 7b: side-light function; and

one light source 7c: 3-function repeating light function.

Referring to FIG. 4, the modular light bar light bar 1 of FIG. 1 is shown according to an exploded and partial perspective view.

In particular, there are shown the four electronic boards (3, 3a, 3b, 3c) of the modular light bar 1, namely the electronic board 3a of the master module 2a, the electronic boards 3c of the two secondary modules 2c, positioned at the center of the modular light bar 1, and the electronic board 3b of the slave module 2b. In the figure, the electronic boards (3, 3a, 3c) of the master module 2a and of the secondary modules 2c are shown while connected to one another, using the connectors 5, whereas the electronic board 3b of the slave module is represented while not connected yet to the electronic board 3c of the adjacent secondary module 2c.

For clarity reasons, the light sources are not represented on the electronic boards (3b, 3c) of the slave module 2b and of the secondary module 2c directly adjacent to said slave module 2b.

The electronic board 3a of the master module 2a has the light sources (7, 7a, 7b, 7c) represented in FIG. 3. The electronic board 3c of the secondary module 2c adjacent to the master module 2a includes the following light sources 7:

two light sources 7a: flashing beacons functions;

two light sources 7d: flashers functions; and

two light sources 7e: work lamps functions.

For example, the electronic board 3c of the secondary module 2c adjacent to the slave module 2b may comprise the same set of light sources (7, 7a, 7d, 7e) as that of the electronic board 3c of the secondary module 2c adjacent to the master module 2a, or may comprise a different set of light sources.

Similarly, the electronic board 3b of the slave module 2b in one form comprises the same set of light sources 7 as that of the master module 2a, but may possibly comprise a different set of light sources 7.

The electronic board 3 of each module 2 may also comprise an indicator light source (not represented in the figures), adapted to light up when said module 2 is defective, for example when said module 2 no longer functions or does not function properly.

The master module 2a receives the electric power supply necessary to the operation of all of the modules 2 of the modular light bar 1 via a cable 12 connected to an electric power source 13 external to the modular light bar 1. In FIG. 4, the cable 12 passes beneath the module 2c before plugging to the master module 2a.

In one form, the cable 12 for connection with the external electric power source 13 is the unique wired link of the modular light bar 1 according to the present disclosure. Thus, the electromagnetic compatibility of the modular light bar 1 according to the present disclosure is quite effective.

Each module 2 of the modular light bar 1 may include a support 8 adapted to receive the electronic board 3 of the module, as well as a cap 9 adapted to protect the electronic board 3 and the light sources disposed on the electronic board 3.

Thus, referring to FIG. 4, there also represented, connected together, the support 8a of the master module 2a and the support 8c of the secondary module 2c adjacent to the master module 2a. In this figure, there are also represented, also connected together, the cap 9a of the master module 2a and the cap 9c of the secondary module 2c adjacent to the master module 2a.

In this figure, there are also represented, also connected together, the cover 10a of the master module 2a and the cover 10c of the secondary module 2c adjacent to the master module 2a. For example, the covers 10a and 10c allow protecting the caps (9a, 9c) from impacts, weather conditions such as rain, etc. They also allow conferring a particular style on the modular light bar 1 when desired.

The modular light bar 1 also comprises a frame 11 adapted to support all of the modules 2 of the bar. Thus, the length of the frame 11 may vary depending on the number of modules 2 forming the modular light bar 1. The frame 11 allows facilitating mounting of the modules 2 on the vehicle 100, and stiffening of the modular light bar 1, which may turn out to be particularly important when the modules 2 are assembled to one another only by the connectors 5.

The supports 8 of the modules 2 may be removably fastened to the frame 11 by any known fastening elements/devices, such as for example self-drilling screws.

The frame 11 may be fastened to a bodywork element of the vehicle 100 (see FIG. 1) by any known fastening elements/devices, such as for example fastening legs (not shown) fastened on the roof and/or on a roof-rack and/or on a roof gutter.

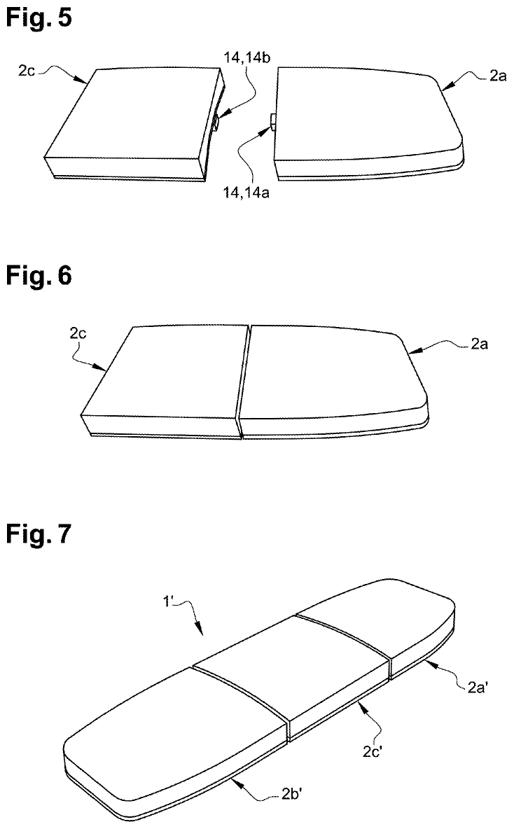

Referring to FIG. 5, there are represented the master module 2a and the adjacent secondary module 2c, while not connected yet. These two modules (2a, 2c) may be mechanically connected to one another by a male/female interlocking type linkage 14. In the figure, the master module 2a comprises the male interlocking portion 14a, and the secondary module 2c comprises the female interlocking portion 14b. Such an interlocking allows tying and untying the link between the two modules in an extremely simple and quick way. In FIG. 6, the two modules (2a, 2c) of FIG. 5 are shown in the interlocked configuration.

According to a possible variation, the male/female interlocking may be achieved by the connector 5, as described in detail below.

Referring to FIG. 7, there is shown a modular light bar 1′ according to the present disclosure similar to the modular light bar 1 of FIGS. 1-6, the modular light bar 1′ being different from the latter essentially in that it comprises only three modules, namely one master module 2a′, one slave module 2b′, both located at each end of the modular light bar 1′, and one secondary module 2c′, at the center. In this figure, the modular light bar 1 is shown mounted, all modules (2a′, 2b′, 2c′) being assembled and connected to one another.

Thus, in the modular light bar (1, 1′) according to the present disclosure, the first set-up of one module or the replacement of one module by a module of the same type (master, slave or secondary) are particularly easy and quick to carry out, with regards to the electric connection (by the connectors 5 connecting the electronic boards 3 to one another), and with regards to the mechanical connection (by the above-described male/female type interlocking). Thus, the downtime of a vehicle, necessary to such an installation or repair, is considerably shortened.

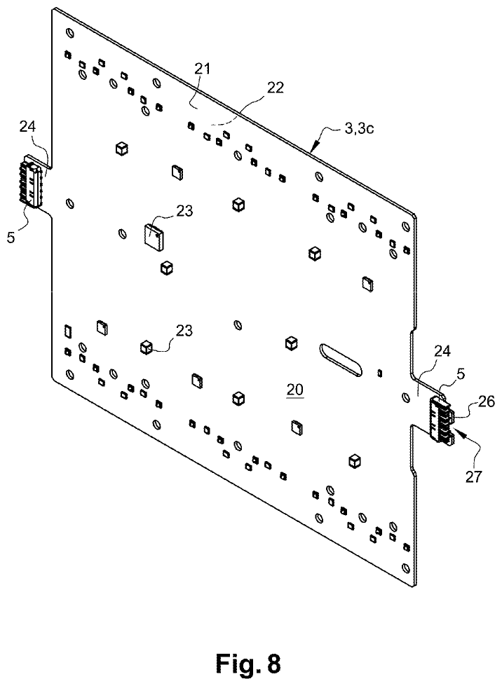

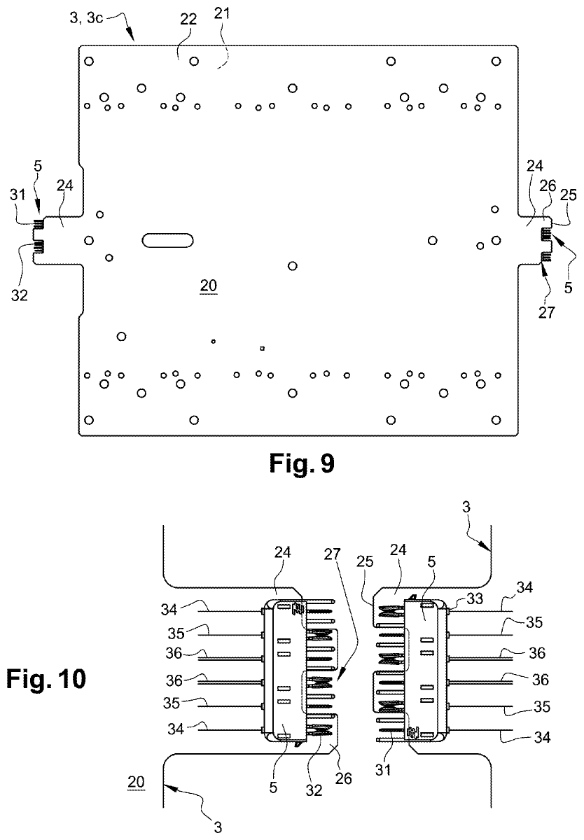

FIGS. 8 and 9 represent an electronic board 3, herein the electronic board 3c of a secondary module 2c.

The electronic board 3 includes a main portion 20 which may be substantially rectangular, and which includes a first face 21, directed upwards in the use position, and an opposite second face 22. The first face 21 may carry the different electronic components 23 as well as the light sources 7 (not represented in FIGS. 8 and 9).

The electronic board 3 further includes at least one protrusion 24 projecting from the main portion 20, in the transverse direction of the vehicle 100 in the use position. The electronic board 3c of a secondary module 2c includes two protrusions 24 projecting from two opposite edges of the main portion 20, in opposite directions.

The free edge 25 of each protrusion 24 may form a crenellation-like shape including at least one tooth 26 and one recess 27, in this instance a series of two teeth and two recesses as shown in particular in FIG. 9.

One connector 5 is connected on each protrusion 24, in the vicinity of its free edge 25. The connector 5 includes pins of a first type, in the form of a plate 31, and pins of a second type, in the form of a jaw 32, these pins extending opposite the main portion 20, that is to say outwards of the module 2. In one form, all connectors 5 are identical and arranged symmetrically so as to be able to be mutually connected as will be seen hereinafter.

As schematically represented in FIG. 10, each pin 31, 32 of one connector is electrically connected, within the connector 5, to a terminal 33 that is, in turn, connected to a track of the electronic board 3. In the represented form, there are six terminals 33 including: two terminals connected a positive power supply track 34, typically 24 V; two terminals connected to a ground track 35; and two CAN buses 36 (or analogous).

The assembly of two electronic boards 3 of two adjacent modules 2 is illustrated in FIG. 10.

The protrusions 24 have complementary shapes, typically symmetrical, in the vicinity of their free edges 25, so that they can cooperate. Thus, the teeth 26 and recesses 27, or any other suitable shape, form a pre-guide member intended to cooperate with the pre-guide member of an adjacent module 2 so as to guide the mutual approach of said modules 2 before the mechanical and electronic assembly thereof.

When the modules 2, and therefore the electronic boards 3, are brought closer to one another, the connectors 5 fit into each other, the jaws 32 of one connector 5 receiving the plates 31 of the other connector 5. With this form, the connectors 5 provide:

on the one hand, the electronic connection, that is to say the connection of the conductors or tracks 34, 35 enabling the electric power supply and the CAN bus link 36 enabling the information communication;

and on the other hand, the mechanical linkage, the pins 31, 32 forming the male/female interlocking 14;

and that in one single assembly gesture, regardless of the modules 2 selected by the user, according to his needs.

Hence, the modular light bar 1, also referred to as a modular light-signaling device 1, is very simple to implement and to customize. In addition, it provides an enhanced mechanical robustness and generates little electromagnetic disturbances.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A modular light-signaling device for a vehicle, the modular light-signaling device comprising:
a plurality of modules, each module comprising an electronic board on which is/are disposed one or several light source(s), each light source having a dedicated lighting function, the plurality of modules comprising at least one master module and at least one slave module, the master module comprising a control unit adapted to pilot the lighting function(s) of the master module and of the slave module,
wherein the plurality of modules are mechanically connected to one another by a male/female interlocking type linkage, and each electronic board comprising at least one connector, electronic boards of two adjacent modules being connected by the connectors, the connection between the two adjacent modules being free of any wired link.

2. The modular light-signaling device according to claim 1, wherein the plurality of modules are mechanically connected to one another by the connectors of the electronic boards.

3. The modular light-signaling device according to claim 1, wherein each connector includes pins of a first type, in the form of a plate, and pins of a second type, in the form of a jaw, the connectors of two adjacent modules configured to be connected to one another being identical and arranged on respective electronic boards of the plurality of modules such that a jaw of one connector receives a plate of an adjacent connector.

4. The modular light-signaling device according to claim 1, wherein each module comprises a pre-guide member configured to cooperate with a pre-guide member of an adjacent module so as to guide a mutual approach of the plurality of modules before mechanical and electronic assembly thereof.

5. The modular light-signaling device according to claim 4, wherein each electronic board of a module includes a main portion and a protrusion projecting from the main portion, the pre-guide member being formed on the protrusion, and the connector being mounted on the protrusion.

6. The modular light-signaling device according to claim 1, wherein the plurality of modules further comprises one or several secondary module(s), the control unit of the master module being adapted to pilot the lighting function(s) of the secondary module(s).

7. The modular light-signaling device according to claim 1, wherein the connectors are configured so as to achieve a connection between at least one of CAN bus type links, multiplexed communication links, and LIN bus type links provided on electronic boards of adjacent modules, so as to provide data transmission between the plurality of modules.

8. The modular light-signaling device according to claim 1, wherein each light source of each module receives information for operation thereof from at least one of the control unit of the master module via a printed circuit in the electronic board(s) of the plurality of modules and corresponding connectors.

9. The modular light-signaling device according to claim 1, wherein the master module receives electric power for operation of the plurality of modules via a wired link communicating with an electric power source external to the modular light-signaling device.

10. The modular light-signaling device according to claim 1, wherein the lighting function(s) of the plurality of modules are selected from the group consisting of flashers, flashing beacons, work lamps, side-lights, 3-function repeating lights, traffic lights, and combinations thereof.

11. The modular light-signaling device according to claim 1, wherein each module comprises an indicator light source, adapted to light up when the module is defective.

12. The modular light-signaling device according to claim 1, further comprising a frame adapted to support all of the plurality of modules forming the modular light-signaling device.

13. The modular light-signaling device according to claim 1, wherein each module comprises a support adapted to receive the electronic board, and a cap adapted to protect the electronic board and the light source(s) disposed on the electronic board, the cap being configured so as to let light pass.

14. A vehicle comprising a modular light-signaling device according to claim 1, the modular light-signaling device being fastened on the vehicle.

15. The vehicle according to claim 14, wherein the modular light-signaling device is fastened on a roof of the vehicle.
